(19) United States
(12) Patent Application Publication
(10) Pub. No.: US 2011/0227693 A1
(43) Pub. Date: Sep. 22, 2011

(54) Environmental Access Control System

(76) Inventor: Bryan David Ekus, Orlando, FL (US)

(21) Appl. No.: 12/695,217

(22) Filed: Jan. 28, 2010

(51) Int. Cl. G05B 23/02

(52) U.S. Cl. 340/3.1

(57) ABSTRACT

An access control system (10) includes a door (11), a locking device (15) which includes a latch (16) which is moveable from a locking position in which the latch (16) prevents the door (18) being opened and a released position in which the latch (16) permits the door (11) to be opened, the locking position to the released position, a controller (22) for operating the release mechanism (20), a dispenser (40) for dispensing on each dispense, a quantity, of an antibacterial agent, an actuating device (25a,25b, 31) for providing a first, command, signal to the controller (22) to operate the release mechanism (20) for moving the latch (16) to the released position, a sensor (44) to sense use of the dispenser (40), a sensor (49) to confirm receipt or the solution and correct usage and to provide a second, sensor, signal to the controller (22) to indicate that the dispenser (40) has been used correctly, the controller (22), on receipt of both the first and second signals operating the release mechanism (20) to move the latch (16) to the release position.

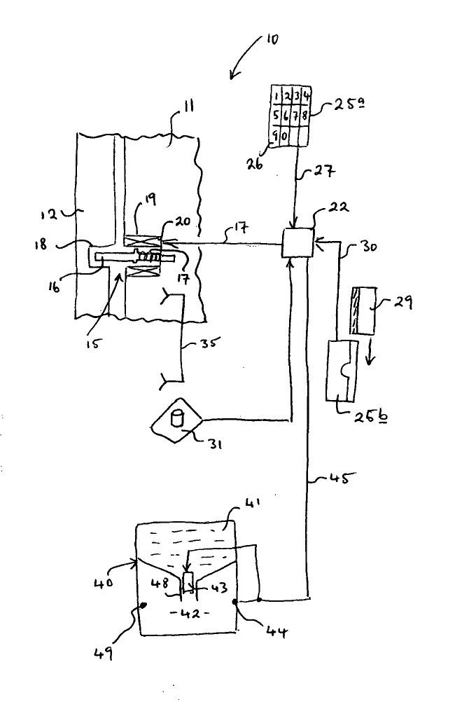

This invention relates to an access control system and more particularly but not exclusively to an access control system for use in a medical context.

It is known to control access to, for example, a hospital ward, operating theatre or the like, through a door, by using a keyless locking device. This may be for security reasons but predominately in an effort to alleviate the spread of diseases and secondary infection such as MRSA throughout the hospital. Such control may be provided at the door by combination lock or a magnet or similar card operated lock, so that the ward may readily be accessed by authorized personnel, and/or from a remote location, such as a nurses' station within the ward, or other access controlled area, as part of an intercom system, to permit controlled entry by visitors.

It is also known to provide at the entrance to a ward or operating theatre etc. for examples only, a dispenser for dispensing antibacterial agent, typically an alcohol-based gel material, onto the hand or hands of a person about to enter the ward, in an effort to reduce the possible transfer of infecting organisms from the hands. Unfortunately, audits have shown that usage rates of both staff and visitors to the ward etc. may not be anywhere as high as expected and so the provision of such dispensers, intended to encourage use by all persons entering the ward. etc. is not as effective as should be the case.

According to a first aspect of the present invention we provide an access control system including a door, a locking device which includes a latch which is moveable from a locking position in which the latch prevents the door being opened and a released position in which the latch permits the door to be opened, the locking position to the released position, a controller for operating the release mechanism, a dispenser for dispensing on each dispense, a quantity of an antibacterial agent, an actuating device for providing a first, command, signal to the controller to operate the release mechanism for moving the latch to the released position, a sensor to sense use of the dispenser and to provide a second, sensor, signal to the controller to indicate that dispense has been used, the controller, on receipt of both the first and second signals operating the release mechanism to move the latch to the released position.

Importantly, the invention incorporates a device to confirm by means of biometric and/or heat sensing that the required anti bacterial agent has been dispensed onto the skin of the individual requesting access before the door is opened, this is vitally important to avoid the individual using another object such as a magazine or other prop to accept the gel and therefore negating the effectiveness of such a device containing solution in reducing the spread of germs, disease and bacteria in a critical environment.

It will be appreciated that in a typical prior arrangement, there may be provided for the door, a combination lock or swipe card reader for authorized personnel, an intercom call button for visitors to request access, as well as a dispenser for the antibacterial agent. The present invention provides a system which may combine these functions, but any person, authorized personnel or visitors, will be now be required to operate the dispenser which will confirm gel being dispensed onto the hand, before the controller will operate the release mechanism to move the latch to the released position, and thus the system will enforce the use of the dispenser and lead to a significantly reduced spread of infection.

The actuating device for providing the command signal to the controller may thus be a security identification device such as an electronic combination lock (when the correct combination is selected on a keypad), and/or a coded tag reader (such as a magnetic card reader), and/or a biometric reader (such as a fingerprint or retinal reader), and/or a manually operable, usually remotely located, signaling device. The actuating device where a security identification device may be mounted on the door, or adjacent the door, for example on or near a doorframe, or nearby wall, and may be connected by cabling to the controller, or may signal the controller via a wireless link.

The dispenser for dispensing the antibacterial agent may be mounted on the door or adjacent to the door. The sensor may sense the proximity of a person's hand or hands to the dispenser to sense use of the dispenser, for example where the dispenser is manually operated, but importantly, the dispenser automatically dispenses a quantity of the antibacterial agent upon sensing a person's hand and not another object in an appropriate place to receive the quantity of antibacterial agent, by touch or proximity, and the sensor upon sensing a person's hand providing the second, sensing, signal to the controller.

The controller may be mounted on the door or adjacent to the door, or may be provided remotely of the door, and may be connected by cabling or wireless connection to the sensor of the dispenser and to the release mechanism.

The locking device may be mounted in or on the door or adjacent to the door e.g. in or on a frame of the door, together with the release mechanism. The release mechanism, typically may be solenoid or magnetically operated, and may move the latch against the force of resilient device such as a spring, to the released position.

According to a second aspect of the invention we provide a method providing access by opening a door, using an access control system of the first aspect of the invention, the method including providing a first, command, signal to the controller, dispensing a quantity of the antibacterial agent thus to generate a second, sensor, signal and providing the second signal to the controller, and upon the release mechanism being operated by the controller to move the latch to the released position, opening the door.

Embodiments of the invention will now be described with reference to the accompanying drawing which is a purely schematic and illustrative view of an access control system in accordance with, or which may be operated according to, the invention.

Referring to the drawing, an access control system 10 is shown. The system 10 is provided for a door 11, at the entrance to a hospital ward, although the invention may be applied for controlling access to other areas, for example to control entry to a hospital operating theatre or other hospital department, especially where hygiene in the department is important. However, the invention has application generally in a medical/scientific context where it is desired to enforce the use of an antibacterial agent for hand cleansing for every person entering the access-controlled area.

In the example, the door 11 is provided in a frame 12 to which the door 11 is hinged, pivoted, or otherwise mounted for opening, e.g. by sliding. The example is more appropriate for a hinged/pivoted door 11.

The system 10 includes a locking device 15, which is mounted in the door 11 in this example, but could not be mounted in the frame 12. The locking device 15 includes a latch 16 (also describable as a bolt) which is moveable linearly in the example (but could be pivotable or otherwise moveable) from a locking position as shown in the drawing, to which the latch 16 is biased by a resilient device such as a spring 17, in which locking position the latch 16 engages with a keeper 18 of the frame 12 to prevent the door 11 being opened, and a released position in which the latch 16 is retracted from the keeper 18 and permits the door 11 to be opened. The latch 16 is moved to the released position by retracting the latch 16 into a body 19 of the locking device 15, by a release mechanism 20, which in the present case is a solenoid.

The release mechanism 20 of the locking device 15 is operated by a controller 22 which may be mounted on the door 10, the frame 12 or otherwise adjacent the door 11 or remotely, although desirably, the locking device 15 and controller 22 are an integrated unit.

Various alternative actuating devices are illustrated for providing a command signal to the controller 22, for operating the release mechanism 20.

The actuating device may in one example be a security identification device such as an electronic combination lock 25a which has a keypad 26 for inputting a number or other combination. If the input is correct, the combination lock 25a provides the command signal to the controller 22 via suitable cabling 27. The controller 22 then looking for confirmation from biometric and/or heat sensors that the solution has been dispensed onto the hand(s). The combination lock 25a may be mounted on the door 11, or adjacent to the door 11, for example on the frame 12 or a wall nearby.

Alternatively the security identification device may be a coded tag reader 25b which may read by swiping, a magnetically encoded ID card 29, but the reader 25b could read an alternatively encoded tag, such as a tag which is able to emit a unique radio signal, or the identification device 25b may even be a stand alone biometric/heat sensing device such as a fingerprint or retinal scanner.

In each case, the security identification device 25a, 25b is able to recognize authorized and solution recipient personnel and provide a command signal to the controller 22, e.g. along cabling 30.

In the drawing yet another actuating device is indicated, namely a remotely located manually operable signaling device, such as a push-button switch 31. Typically this would be provided, e.g., in a hospital ward context, at a nurses' station or otherwise at a location from where the door 11 access is controlled. The access control system 10 thus could include an intercom 35 so that a visitor example, can request entry through the door 11, and as desired, the manually operable signaling device 21 might be operated to provide a command signal to the controller 22 along cabling 32. This would also incorporate an override facility to come into effect and with suitable visual or audible notification of it usage in the event of an emergency such as cardiac arrest or fire as examples only and further incorporate a remote or otherwise manual override facility operable both locally and remotely, in the event of malfunction or otherwise.

It is envisaged that the access control system 10 will include both a security identification device such as the combination lock 25a, or coded tag reader 25b or biometric sensor or heat sensor (or any combination of these) and the manually operable signaling device 31. Thus, the door 12 may be self opened by authorized personnel with the correct code or coded tag or other security ID or biometric features, and signaled to open by a nurse or other person responsible within the area to which access is to be controlled.

The access control system 10 includes a dispenser 40 for dispensing in each dispenses a quantity of an antibacterial agent from a reservoir 41, onto the hands or hands of a person wishing to enter the access-controlled area.

The dispenser 40 includes a housing 42 into which a person must insert at least one hand, in order to activate a sensor 44 which sense the proximity of the person's hand or hands. The sensor 44 may be an infrared or any other kind of proximity sensor, or in another example, a touch sensor. In each case, when the sensor 44 senses that the dispenser 40 is used, the sensor 44 generates a control signal to secondary and/or incorporated sensor 49 confirming by way of biometric and/heat that it is indeed an individuals hand that has been inserted into the device and then send a command signal to a dispense valve 43 so that a quantity of the antibacterial agent, which is usually an alcohol-based gel or the like, is dispensed from a nozzle 48 onto the person's hand or hands in the housing 42. Also, the sensors 44 and 49 provides a sensing signal along cabling 45 to the controller 22.

In another example, the antibacterial agent may be manually dispense from the dispenser 40, for example by a person operating a dispensing lever or the like to operate a manual dispensing valve, but the sensors 44 and 49 would still be required to provide the second, sensing, signals to the controller 22 which responds as will now be described.

The controller 22 is arranged only to actuate the release mechanism 20 in response to two conditions being met, the first being receipt of a command signal from the security identification device i.e. electronic lock 25s, the/or coded tag reader 25b or the manually operable signaling device 31, and the second being the receipt of a sensing signal from the sensors 44 and 49 which indicates that the dispenser 40 has been used to dispense and importantly confirm a quantity of antibacterial agent onto the hand or hands of a person wishing to enter the ward or other access controlled area.

Thus, whether the person wishing to enter is an authorized person with appropriate security ID, or a visitor, the person is enforced to use the dispenser 40 for hygiene purposes before entering the access-controlled area.

Of course the person may think it possible to deliberately operate the sensor 44 and 49 and not to dispense or to remove his or her hands without and before receiving the quantity of antibacterial agent if the person is determined, but the system 10 provides, as well as every incentive to persons to use the dispenser 40 and thus take the necessary hygienic precautions before entering the access controlled area. a delay in respect of the biometric and/or heat sensing device 49 that the hands must remain present, and therefore in receipt of the solution, throughout the time period that it takes to dispense the solution otherwise the controller 22 would ask for reinsertion of the hands practically making cleaning of the hands compulsory for admission to the area requested.

Various modifications in addition to those already indicated may be made without departing from the scope of the invention. For example, instead of the cabling 27, 30, 32, 45 between the controller 22 and the actuating devices 25a, 25b, 31 and dispenser 40, if desired at least some of this cabling 27, 30, 32 may be replaced by a wireless connection, as could cabling 17 between the controller 22 and the release mechanism 20.

In each case, of course a locking device 15 release needs to be provided for releasing the locking device 15 from inside the access-controlled area. This could be a manual push button at or adjacent to the door 11 for example which provides a signal to the controller 22 to operate the release mechanism 20 without requiring any other signal e.g. from the dispenser 40, or a proximity sensor for sensing a person approaching the door 11. Alternatively, a dispenser for dispensing antibacterial agent may be provided inside access controlled area which may be require to be used before the door 11 can be opened to permit a person to leave the access controlled area in the same manner as dispenser 40.

The door 11 may be manually openable by hinging, pivoting, or sliding, or desirably, the door 11 is automatically openable by a power-operated door opener, which operates in concert with the lock release mechanism 20.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, utilized for realizing the invention in diverse forms thereof.

1. An access control system including a door, a locking device which includes a latch which is moveable from a locking position in which the latch prevents the door being opened and a released position in which the latch permits the door to be opened, the locking position to the released position, a controller for operating the release mechanism, a dispenser for dispensing on each dispense, a quantity of an antibacterial agent, an actuating device for providing a first, command signal to the controller to operate the release mechanism for moving the latch to the released position, a sensor to sense and confirm use of the dispenser in the required way and to provide a second, sensor, signal to the controller to indicate that the dispenser has been used the solution received, the controller, on receipt of both the first and second signals operating the release mechanism to move the latch to the released position.

2. A system according to claim 1 wherein the device dispenses and confirms receipt of an antibacterial agent on the hands before providing a signal to the controller to automatically open a door

3. A system according to claim 1 wherein the actuating device for providing the command signal to the controller is a security identification device.

4. A system according to claim 3 wherein the actuating device is an electronic combination lock and/or a coded tag reader and/or a biometric reader.

5. A system according to claim 1 or claim 3 wherein the actuating device is a manually operable signaling device.

6. A system according to any one of claims 1 to 5 wherein the actuating device is mounted on the door or adjacent the door and is connected by cabling or wireless link to the controller.

7. A system according to any one of claims 1 to 6 wherein the dispenser for dispensing the antibacterial agent is mounted on the door or adjacent the door.

8. A system according to any one of the preceding claims wherein the sensor senses the proximity and composition of a person's hand or hands to the dispenser to sense use of the dispenser.

9. A system according to any one of the preceding claims wherein the dispenser automatically dispenses a quantity of the antibacterial agent upon sensing a person's hand in an appropriate place, and the correct composition and/or temperature, to receive the quantity of antibacterial agent, by touch or proximity, and the sensor upon sensing a person's hand and after a delay to ensure receipt of the said solution provides the second, sensing, signal to the controller.

10. A system according to any one of the preceding claims wherein the controller is mounted on the door or adjacent to the door, or is provided remotely of the door, and is connected by cabling or wireless connection to the sensor of the dispenser and to the release mechanism.

11. A system according to any one of the preceding claims wherein the locking device is mounted in or on the door or adjacent to the door together with the release mechanism.

12. A system according to anyone of the preceding claims wherein the release mechanism moves the latch against the force of a resilient device to the release position.

13. An access control system substantially as hereinbefore described with reference to and/or as shown in the accompanying drawings.

14. A method providing access by opening a door, using an access control system of the first aspect of the invention, the method including providing a first, command, signal to the controller, dispensing and confirming receipt of a quantity of the antibacterial agent thus to generate a second, sensor, signal and providing the second signal to the controller, and upon the release mechanism being operated by the controller to move the latch to the released position, opening the door.
